(19) United States
(12) Patent Application Publication
(10) Pub. No.: US 2004/0246514 A1
(43) Pub. Date: Dec. 9, 2004

(54) Systems and methods for printing using a public printing service

(76) Inventors: James Clough, Boise, ID (US); Brian E. McKinley, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/455,203

(22) Filed: Jun. 5, 2003

(51) Int. Cl. G06F 3/12; H04L 9/00; G06F 15/00

(52) U.S. Cl. 358/1.14; 358/1.15; 713/150

(57) ABSTRACT

Disclosed are systems and methods for printing using a public printing service. In one embodiment, a system and a method pertain to formatting a print job for transmission via a secure network protocol, and transmitting the print job directly to a printing device of the service such that the printing device receives a secure network protocol-formatted print job.

### BACKGROUND

Computer users often carry portable computing devices with them such as notebook computers, personal digital assistants (PDAs), and mobile telephones that include computing capabilities. Such users may at some point wish to print data from the portable computing device while remote from the user's work or home network. For instance, a mobile user may wish to print when at a coffee shop that provides network (e.g., internet) access and printing services, or when staying at a hotel that comprises a hotel network that includes a public printing device.

In such scenarios, it is likely that the user has little or no knowledge of the printing services that are available for use. Furthermore, it is likely that the user lacks the software (or firmware) that is required to communicate with the public printing devices and to send print jobs to them. Although the user can be provided with information as to the availability of printing services as well as any software or firmware (e.g., drivers) that is necessary to print, a more automated public printing system would be preferable, particularly for less computer-savvy users. Moreover, desirable would be a public printing system that is substantially universal and therefore may be used within any network that is configured to support such public printing.

One concern in designing such a public printing system is security. In particular, security (e.g., encryption) would be used for all communications containing potentially sensitive information. Although such security preferably would comprise end-to-end security that extends from the source device to the printing device, known “secure” print systems typically only provide security for the path that extends to a print server that then forwards print jobs to a printing device in an unencrypted communication. Therefore, such security does not extend to the “last mile” traversed by the print job in reaching the printing device.

### SUMMARY

Disclosed are systems and methods for printing using a public printing service. In one embodiment, a system and a method pertain to formatting a print job for transmission via a secure network protocol, and transmitting the print job directly to a printing device of the service such that the printing device receives a secure network protocol-formatted print job.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system that facilitates public printing.

FIG. 2 is a block diagram of an embodiment of a computing device shown in FIG. 1.

FIG. 3 is a block diagram of an embodiment of a printing device shown in FIG. 1.

FIGS. 4A and 4B provide a flow diagram that illustrates an embodiment of a method for facilitating public printing using the system of FIG. 1.

FIG. 5 is a flow diagram that illustrates an embodiment of operation of a public printing client in printing to a printing service.

FIG. 6 is a flow diagram that illustrates an embodiment of operation of a printing service manager in receiving a print job transmitted by the public printing client.

### DETAILED DESCRIPTION

Disclosed herein are example embodiments of systems and methods that facilitate public printing. Although particular embodiments are disclosed, these embodiments are provided for purposes of example only to facilitate description of the disclosed systems and methods.

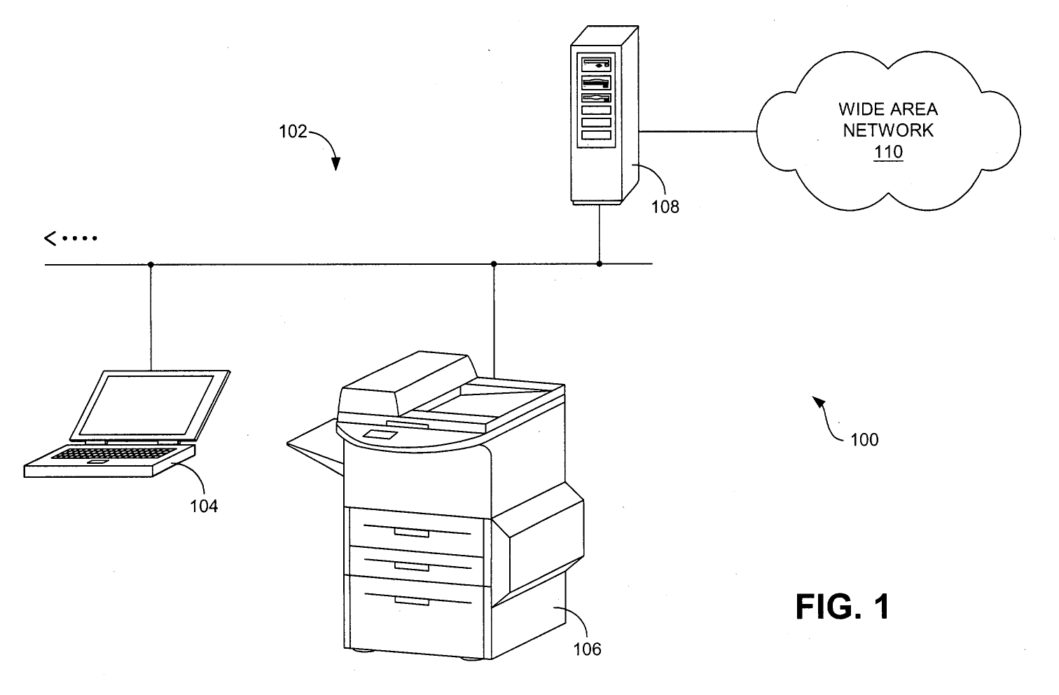

Referring now in more detail to the drawings, in which like numerals indicate corresponding parts throughout the several views, FIG. 1 illustrates an example system 100 that facilitates public printing. As indicated in this figure, the system 100 includes a local or internal network 102 to which a computing device 104, a printing device 106, and a server computer 108 are connected. The internal network 102 is assumed to comprise a network that is unfamiliar to the mobile user. By way of example, the internal network 102 comprises a hotel network to which the user can connect from the user's hotel room. Although a hotel network is explicitly identified for purposes of discussion, the internal network 102 more generally comprises any network (wired or wireless) that a mobile user may wish to connect to and print over.

As is depicted in FIG. 1, the computing device 104 can be a notebook (or “laptop”) computer. More generally, however, the computing device 104 comprises a portable computing device that the mobile user may carry, for instance, while on a business trip. Accordingly, the computing device 104 can, alternatively, comprise one of a personal digital assistant (PDA), tablet computer, mobile telephone, etc. Irrespective of its configuration, the computing device 104 is connectable to the internal network 102 such that the computing device can communicate with one or both of the printing device 106 and the server computer 108. This connection may comprise either a wired connection or a wireless connection (e.g., via a radio frequency (RF) communication protocol). Stored on the computing device 104 is client software (or firmware) that is used to access and use a public printing service facilitated by a printing service manager.

The printing device 106 comprises any device that can receive print jobs via the internal network 102 and generate hardcopy documents associated with the received jobs. By way of example, the printing device 106 comprises a laser printer. However, other configurations are possible. For instance, the printing device 106 can be a multi-function peripheral (MFP) device that is capable of printing as well as performing other tasks such as copying, scanning, faxing, emailing, etc. As is described in greater detail below, the printing device 106 can comprise an embedded printing service manager that facilitates public printing.

The server computer 108 links the internal network 102 to an external wide area network (WAN) 110, such as the Internet, and therefore acts as a gateway between the internal network and the WAN. As is described below, the server computer 108 is configured to intercept initial communications directed at devices located outside of the internal network 102 (i.e. on the WAN 110). Such interception may be used to, for example, charge users for Internet access and/or offer printing services to the user. In the latter case, the server computer 108 may be configured to provide a link to the printing service manager that is, for instance, embedded in the printing device 106.

In addition to acting as the network gateway, the server computer 108 (or a separate computer if desired) may be used to provide the network address (e.g., Internet protocol (IP) address) of the printing service manager. Furthermore, the server computer 108 may facilitate billing for rendered printing services by, for instance, posting printing charges to a bill (e.g., hotel bill) or forwarding billing information to a credit card processing service connected to the WAN 110. It is noted that, in some embodiments, the printing service manager, or a portion thereof, may exist on the server computer 108 or another device connected to the network 102.

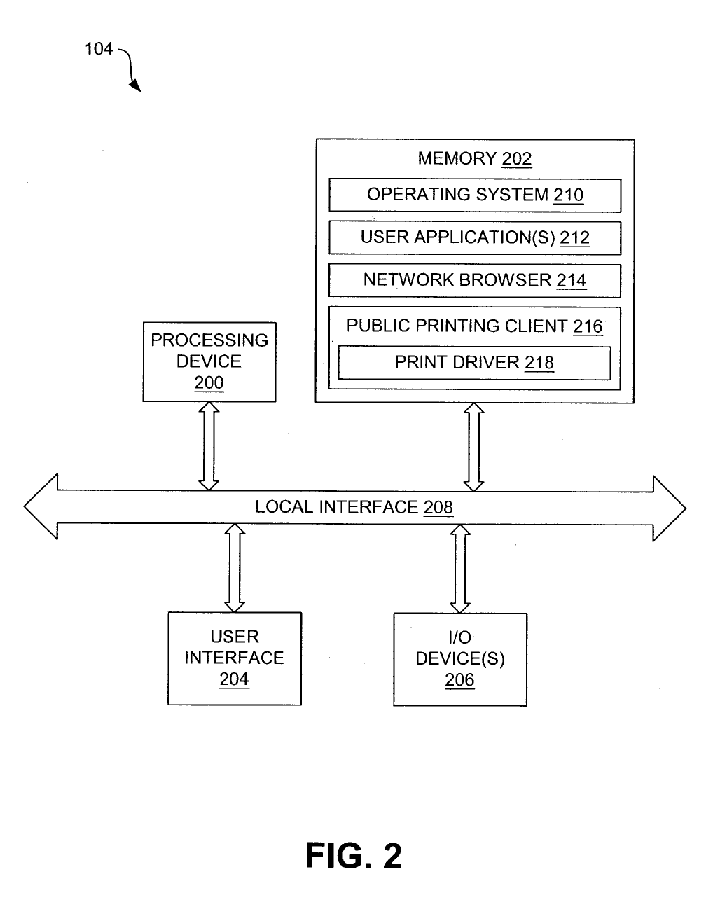

FIG. 2 is a block diagram illustrating an example architecture for the computing device 104 shown in FIG. 1. As indicated in FIG. 2, the computing device 104 comprises a processing device 200, memory 202, a user interface 204, and at least one input/output (I/O) device 206. Each of these components is connected to a local interface 208 that, for instance, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, or other electrical configurations that coordinate the overall operation of the computing device 104. The memory 202 comprises any one or a combination of volatile memory elements (e.g., random access memory (RAM)) and nonvolatile memory elements (e.g., Flash memory, hard disk, etc.) that store or cache data.

The user interface 204 comprises the tools with which user data and commands are input into the computing device 104. In situations in which the computing device 104 comprises a notebook computer, the user interface 204 at least comprises a keyboard and a display. In other embodiments, the user interface may comprise one or more of function keys, buttons, a touch-sensitive display, and a stylus.

The one or more I/O devices 206 facilitate communications with other devices and may include one or more serial, parallel, small computer system interface (SCSI), universal serial bus (USB), or IEEE 1394 (e.g., Firewire™) components, as well as one or more of a modulator/demodulator (e.g., modem), network card, wireless (e.g., RF) transceiver, or other communication component.

The memory 202 includes various programs, in software and/or firmware, including an operating system 210, one or more user applications 212, and a network browser 214. The operating system 210 controls the execution of other software and provides scheduling, input-output control, file and data management, memory management, and communication control and related services. The user applications 212 comprise the programs that may be used to create and/or identify data (e.g., documents) that is to be printed by the service and, more particularly, by the printing device 106. By way of example, these applications comprise one or more of a word processing application, a spreadsheet application, a presentation application, a scheduling application, etc. The network browser 214 comprises a program with which the user can access, via the internal network 102, network sites and pages. By way of example, the network browser 214 is an Internet browser that retrieves Web sites and Web pages. The network browser 214 can be used to access the printing service manager.

In addition to those programs, the memory 202 comprises a public printing client 216. As is described in greater detail below, the public printing client 216 operates in conjunction with the printing service manager to facilitate public printing. By way of example, the public printing client 216 can be downloaded from the printing service manager or from a suitable source on the WAN 110. In any case, however, once stored on the computing device 104, the public printing client 216 can be used to facilitate public printing on any network in which an appropriate printing service manager is provided, thereby providing a substantially universal printing solution.

As is further identified in FIG. 2, the public printing client 216 includes a print driver 218 that is used to translate documents into an appropriate print format. Alternatively, however, the driver 218 could comprise part of the operating system 210. In preferred embodiments, the print driver 218 is a universal driver that can be used in conjunction with substantially any printing device that may be accessed via a compatible printing service manager. Examples of operation of the public printing client 216, and its print driver 218, are provided below.

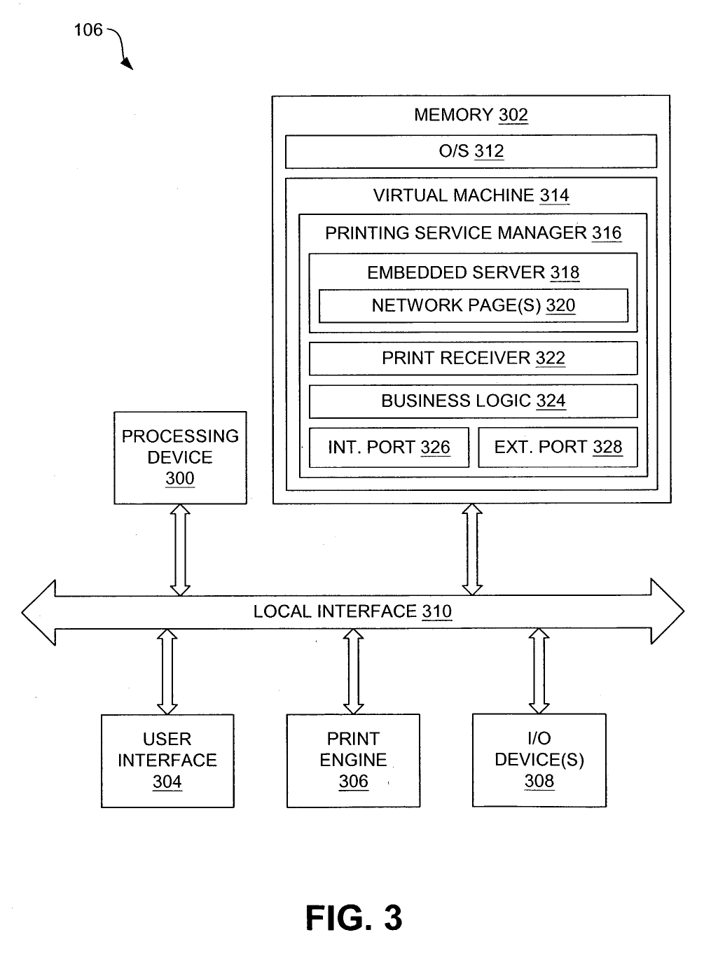

FIG. 3 is a block diagram illustrating an example architecture for the printing device 106 shown in FIG. 1. As indicated in FIG. 3, the printing device 106, like the computing device 104, comprises a processing device 300, memory 302, a user interface 304, and at least one I/O device 308, each of which is connected to a local interface 308. In addition, however, the printing device 106 comprises a print engine 306.

The processing device 300, memory 302, and I/O devices 308 have similar configurations to like-named components of the computing device 104 described in relation to FIG. 2. The user interface 304 comprises the components with which users input commands and modify device settings, such as a control panel that incorporates a display (e.g., liquid crystal display (LCD)) and a series of keys or buttons.

The memory 302 comprises various programs, in software and/or firmware, including an operating system 312 and, in this embodiment, a virtual machine 314. The operating system 312 contains the various commands that are used to control the general operation of the printing device 106. The virtual machine 314 is a program that functions as a self-contained operating environment and facilitates operation of a printing service manager 316 that, as noted above, facilitates public printing. Although a virtual machine is explicitly shown and identified, its functionality could, alternatively, be provided by software or firmware stored in the printing device 106. In the embodiment of FIG. 3, however, the manager 316 comprises an applet (e.g., written in the Chai™ programming language of the Hewlett-Packard Company) that includes an embedded server 318, a print receiver 322, and business logic 324. It is noted that, although the printing service manager 316 is shown as executing on the printing device 106, it could alternatively be provided on a separate device, such as the server computer 108 or another device connected to the internal network 102, if desired.

The embedded server 318 is configured to serve network pages 320, for instance Web pages, to requesting devices such as the computing device 104. As is described below, these pages contain information for the user as to how to use the public printing system hosted by the printing service manager 316, how to obtain public printing client software, the cost of the printing services, the methods of paying for those services, etc.

The print receiver 322 is a module that is configured to receive print jobs transmitted to the printing device 106 via the internal network 102. By way of example, the print receiver 322 is specifically configured to receive hypertext transfer protocol (HTTP) and/or secure HTTP (HTTPS) communications. These communications can be received via an internal port 326 and an external port 328 that each has its own network address (e.g., universal resource locator (URL)) that is used to access the port. In some embodiments, the internal port 326 and the external port 328 may comprise the same port. When a print job is received, the print receiver 322 forwards the job to the print engine 306 for printing.

Once printing has been successfully performed, billing (assuming the printing services are provided on a pay basis) is facilitated using the business logic 324. Operation of the business logic 324 depends upon the particular implementation and method of billing that is to be used. By way of example, the business logic 324 is configured to communicate printing charges to the server computer 108 for purposes of posting those charges to a bill (e.g., hotel bill) or contacting an appropriate credit card processing service.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

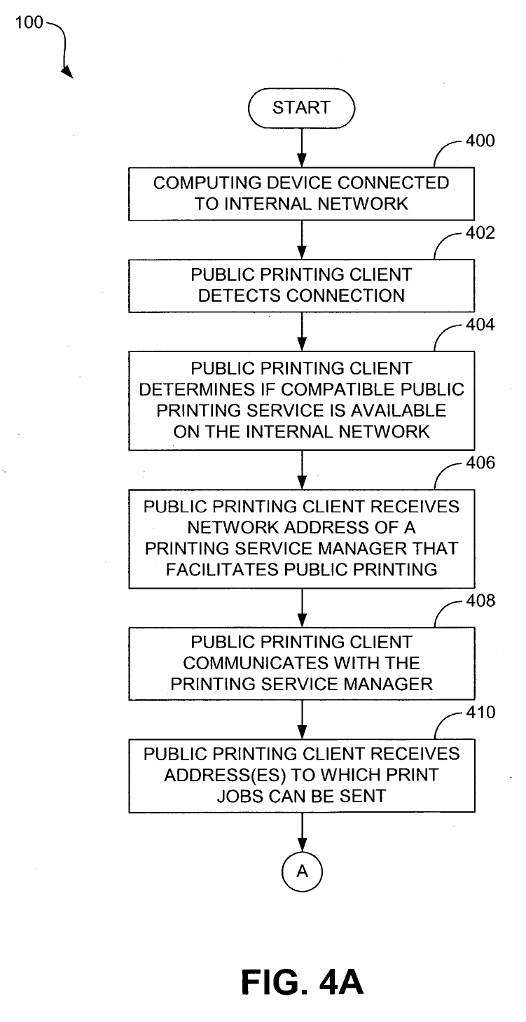

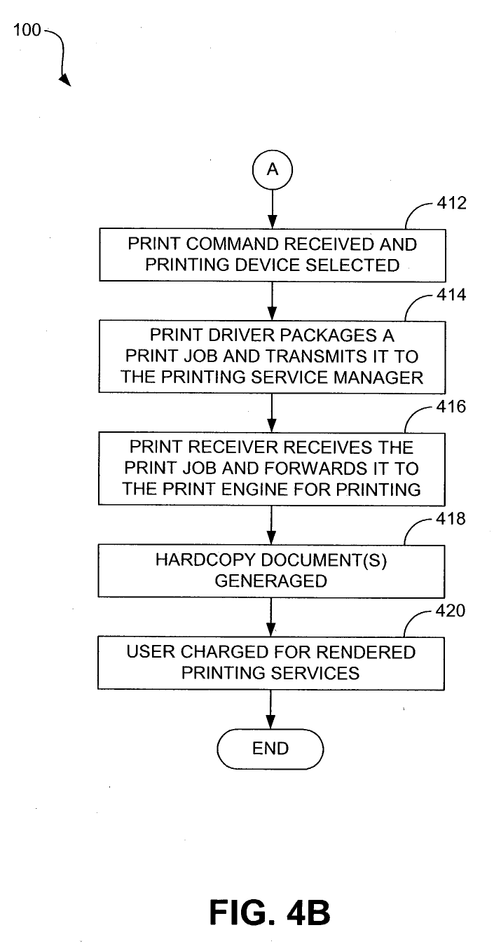

An example system having been described above, an example of operation of the system in facilitating public printing will now be discussed in relation to the flow diagram of FIGS. 4A and 4B. It is noted that process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400 of FIG. 4A, the computing device 104 (FIG. 1) is connected to the internal network 102. By way of example, the computer user may physically connect his or her notebook computer to a hotel network (e.g., high speed data port in the user's hotel room). Once the computing device 104 is connected to the network 102, the public printing client 216 (FIG. 2) on the computing device detects the connection, as indicated in block 402. Such detection can be made because the public printing client 216 continuously runs in the background on the computing device 104 and therefore continually monitors the network state of the device. Notably, the public printing client 216 could have been installed in a previous public printing session. For example, during that session, the computer user could have been made aware of the availability of the client software and the printing services it facilitates by, for example, a Web page served by the server computer 108. In such a case, the client software could have been obtained by, for instance, retrieving it from a server connected to the WAN 110 and operated by or on the behalf of the client software developer.

Referring next to block 404, the public printing client 216 determines if a compatible public printing service is available on the internal network 102. This determination can be made by performing a domain name service (DNS) lookup for a domain name associated with the public printing service that a DNS server (e.g., server computer 108) is configured to recognize. By way of example, a DNS lookup of the name “mobile.printing” can be performed. If a compatible public printing service is available, the public printing client 216 receives a network address of a printing service manager 316 (FIG. 3) that facilitates such public printing, as indicated in block 406. More particularly, the public printing client 216 receives an Internet protocol (IP) address of the printing service manager 316, for example stored on the printing device 106 or the server computer 108 as the case may be.

Once the public printing client 216 receives the address of the printing service manager 316, the public printing client makes a call to that address so that the client can communicate with the printing service manager 316, as indicated in block 408. Such communications are supported using an appropriate network protocol, such as HTTP or HTTPS. Through these communications, the public printing client 216 receives one or more network addresses to which print jobs can be sent for printing by one or more available printing devices 106, as indicated in block 410. By way of example, the address or addresses comprise one or more URLs that identify input ports (e.g., the internal and external ports) of the printing service manager 316 on the printing device 106 or the server computer 108. This information, as well as other information that facilitates printing, can, for instance, be contained in an extensible markup language (XML) document that is transmitted from the printing service manager 316 to the public printing client 216. At this point, the public printing client 216, and therefore the computing device 104, has completed a public printing service discovery process and therefore is prepared to print to the printing device 106.

The user can learn about the public printing service in various ways. For example, when the user opens the network browser 214, the server computer 108 can intercept that connection and inform the user as to the availability of the public printing service and provide a link to the printing service manager 316. Assuming the user wishes to use or is considering using the public printing service, the user can then select the link and receive one or more network (e.g., Web) pages from the embedded server 318 of the printing service manager 316 that explain how to use the service, how much the service costs (e.g., price per page), how the user is billed, where printed documents may be picked up, etc.

At print time, a print command is received and a printing device is selected, as indicated in block 412 of FIG. 4B. By way of example, the print command and printing device selection are made using a “File, Print” process in which the user is presented with a list of available printing devices from which to choose. In such a case, the presented list includes the printing device 106 connected to the internal network 102. After the print command and printing device selection have been entered, and assuming the user selected the printing device 106, the public printing client 216 packages a print job and transmits it to the printing service manager 316, as indicated in block 414. Alternatively, however, packaging of the print job can have occurred previous to entry of the print command and printing device selection. Preferably, the print job is transmitted using a secure network protocol such as HTTPS. Regardless, the print job is transmitted to an address (e.g., URL) that the public printing client 216 received in block 410 described above.

After or while the print job is transmitted, the print receiver 322 of the printing service manager 316 receives the print job and forwards it to the print engine 306 for printing, as indicated in block 416, so that, as indicated in block 418, one or more hardcopy documents are generated. If the printing service manager 316 is executing on a device separate from the printing device 106, for instance on the server computer 108, the print job is transmitted from that device to the printing device using substantially any available transmission method (wired or wireless). Optionally, this transmission can also be via HTTP or HTTPS. Once printing has been successfully completed (in whole or in part), the user is charged for the printing services rendered, as indicated in block 420. As noted above, such a charge can be, for instance, added to a hotel bill or forwarded to a credit card processing service for debiting of a credit card account. Assuming no other documents are to be printed, flow for the public printing session is then terminated.

As noted above, one concern in designing and implementing a public printing system, such as that described above in relation to FIGS. 1-4, is security. In particular, desired is end-to-end security that extends all the way from the source device to the printing device. As is described in the following, such security can be provided if a secure network protocol is used to transmit print jobs to the printing device.

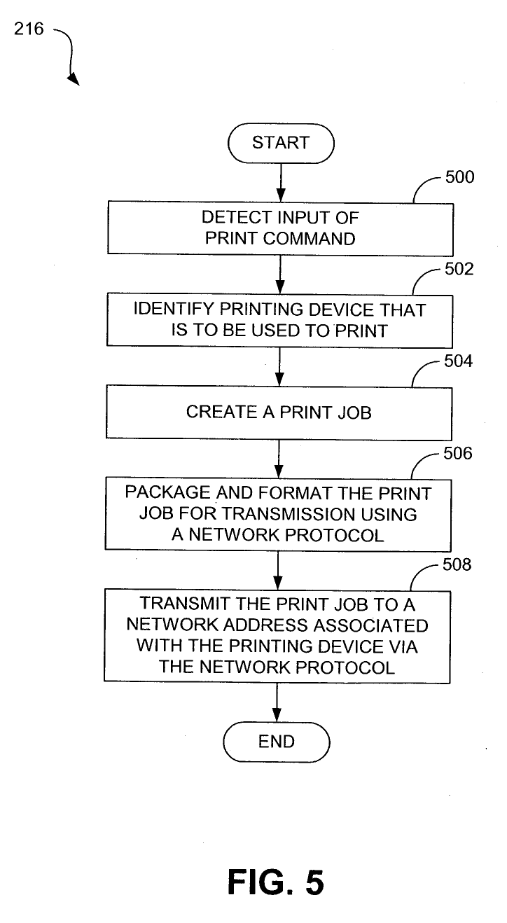

FIG. 5 is a flow diagram that illustrates an example of printing using a public printing service. More particularly, FIG. 5 illustrates an example of operation of the public printing client 216 (FIG. 2) in printing to the printing device 106 (FIG. 1) using a network protocol. Beginning with block 500 of that figure, the public printing client 216 detects input of a print command. This command can have been entered, for example, in substantially any one of the user applications 212. In any case, once the print command is detected, the public printing client 216 identifies the printing device 106 that is going to be used to print, as indicated in block 502. The printing device 106 can be identified by, for example, presenting to the user a list of available printing devices obtained from the printing service manager 316, and receiving the user's selection.

At or around the same time, the public printing client 216, and more particularly the print driver 218, creates a print job that contains the print data that the user has selected for printing, as indicated in block 504. This creation may comprise, for example, translating the data into a printer ready format such as Post Script or printer control language (PCL). Notably, if the print driver 218 is separate from the public printing client 216, the public printing client harnesses the facilities of that print driver (wherever it exists) for creation of the print job.

With reference next to block 506, the public printing client 216 formats and packages the print job for transmission via a network protocol. By way of example, the network protocol comprises HTTP and, where cryptographic security is desired, HTTPS. In the latter case, the print data will be encrypted to protect it from being accessed by unauthorized persons. Once the print job has been prepared, it is transmitted to a network address associated with the printing device 106 via the network protocol (e.g., HTTP or HTTPS), as indicated in block 508. In particular, the print job is posted against a URL (i.e. either the internal URL or the external URL) that was obtained during the discovery process described above in relation to FIG. 4A. It is noted that the transmission from the public printing client 216 to the printing device 106 need not be direct, i.e. the print job may be routed through one or more other devices and/or networks. At this point, flow for the public printing client 216 for the printing session is terminated.

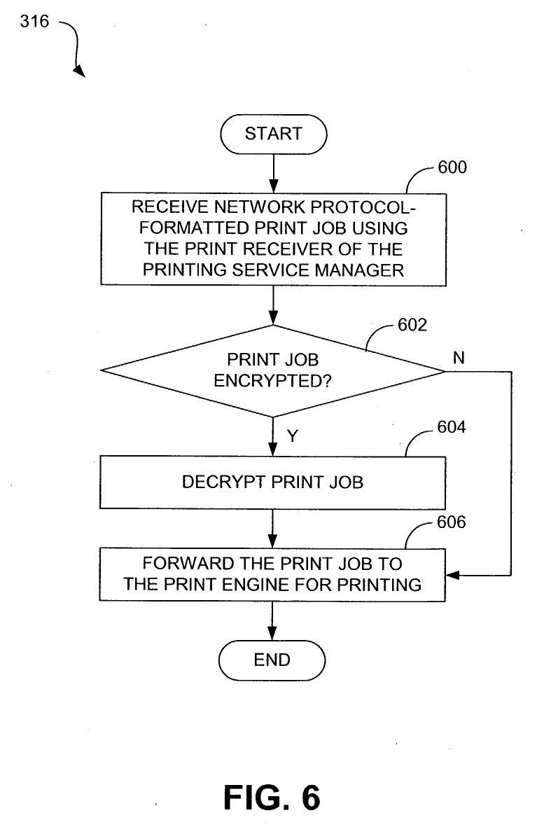

FIG. 6 is a flow diagram that illustrates an example of facilitating printing of a print job transmitted in the manner described above in relation to FIG. 5. Specifically, FIG. 6 illustrates an example of operation of the printing service manager 316 (FIG. 3) in receiving the print job and forwarding it to a print engine for printing. In this example, it is assumed that the printing service manager 316, or at least a portion thereof, exists and executes on the printing device 106 (FIG. 1) such that the printing device directly receives the network protocol-formatted print job.

Beginning with block 600 of FIG. 6, the printing service manager 316 on the printing device 106 receives the network protocol-formatted print job sent by the client 216 (FIG. 2) using the print receiver 322. As noted above in relation to FIG. 3, the print receiver 322 is specifically configured to receive network protocol communications, for instance HTTP and/or HTTPS communications. With reference to decision block 602, if print job is encrypted it is decrypted as part of receiving the data stream, as indicated in block 604. The print job is then forwarded to the print engine 306 for printing, as indicated in block 606.

By posting a print job directly to a printing device as described above in relation to FIGS. 5 and 6, and assuming the use of a secure network protocol such as HTTPS, end-to-end security can be achieved all the way to the printing device. In addition, transmitting the print job via a secure network protocol enables the crossing of firewalls that are configured to block unencrypted transmissions. Furthermore, the use of a network protocol facilitates certificate-based authentication of the public printing client.

What is claimed is:

1. A method for printing using a public printing service, comprising:
formatting a print job for transmission via a secure network protocol; and
transmitting the print job directly to a printing device of the service such that the printing device receives a secure network protocol-formatted print job.

2. The method of claim 1, wherein formatting a print job for transmission via a secure network protocol comprises formatting a print job for transmission via secure hypertext transfer protocol (HTTPS).

3. The method of claim 1, wherein transmitting the print job comprises posting a print job against a universal resource locator (URL) associated with the printing device.

4. The method of claim 1, wherein transmitting the print job comprises posting a secure hypertext transfer protocol (HTTPS) print job against a universal resource locator (URL) associated with one of an internal port and an external port of the printing device.

5. A method for facilitating printing using a public printing service, comprising:
receiving a print job that is formatted for transmission via a secure network protocol using a print receiver of a printing device; and
forwarding the print job to a print engine of the printing device for printing.

6. The method of claim 5, wherein receiving a print job that is formatted for transmission via a secure network protocol comprises receiving a print job that is formatted for transmission via secure hypertext transfer protocol (HTTPS).

7. The method of claim 6, further comprising decrypting the print job before forwarding it to the print engine.

8. The method of claim 5, wherein receiving a print job comprises receiving a print job posted against a universal resource locator (URL) associated with the printing device.

9. A system for printing, comprising:
a printing service manager that executes on a printing device, the manager comprising a print receiver that is configured to receive print jobs formatted for transmission via a secure network protocol; and
a public printing client that executes on a computing device, the client being configured to transmit print jobs to the printing service manager of the printing device via a secure network protocol.

10. The system of claim 9, wherein the print receiver of the printing service manager is configured to receive print jobs that are formatted for transmission via secure hypertext transfer protocol (HTTPS).

11. The system of claim 10, wherein the printing service manager is further configured to decrypt the received print jobs.

12. The system of claim 9, wherein the public printing client is configured to post hypertext transfer protocol (HTTPS) print jobs against a universal resource locator (URL) associated with the printing service manager.

13. A system for printing, comprising:
means for receiving on a printing device print jobs transmitted directly to the printing device via a secure network protocol; and
means for posting print jobs via a secure network protocol against a network address of the printing device.

14. The system of claim 13, wherein the means for receiving comprise means for receiving secure hypertext transfer protocol (HTTPS) print jobs.

15. The system of claim 13, wherein the means for posting comprise means for posting hypertext transfer protocol (HTTPS) print jobs against a universal resource locator (URL) of the printing device.

16. A printing device, comprising:
a processing device;
a print engine; and
memory comprising a printing service manager that includes a print receiver, the print receiver being configured to receive print jobs that are formatted for transmission via a secure network protocol.

17. The device of claim 16, further comprising at least one port that is associated with a universal resource locator (URL) to which print jobs may be directed.

18. The device of claim 17, wherein the print receiver is configured to receive secure hypertext transfer protocol (HTTPS) print jobs posted to the universal resource locator (URL).

19. A public printing client stored on a computer-readable medium, comprising:
logic configured to format a print job for transmission via a secure network protocol; and
logic configured to transmit the print job directly to a network address of a printing device such that the printing device receives a secure network protocol-formatted print job.

20. The client of claim 19, wherein the logic configured to format is configured to format the print job for transmission via secure hypertext transfer protocol (HTTPS).

21. The client of claim 19, wherein the logic configured to transmit is configured to post the print job against a universal resource locator (URL) associated with the printing device.
